(19) United States
(12) Patent Application Publication
(10) Pub. No.: US 2003/0236556 A1
(43) Pub. Date: Dec. 25, 2003

(54) Infant teething device

(76) Inventor: Dan Dickerson, Louisville, KY (US)

Correspondence Address: LATHROP & GAGE LC, 2345 GRAND AVENUE, SUITE 2800, KANSAS CITY, MO, 64108, US

(21) Appl. No.: 10/176,153

(22) Filed: Jun. 20, 2002

(51) Int. Cl. A61J 17/00

(52) U.S. Cl. 606/235

(57) ABSTRACT

The present invention provides an infant teething device having a collar and a teething portion to administer a dosage of medication. The collar extends radially in a first plane and the teething portion extending laterally from the collar and is aligned longitudinally in a direction generally orthogonal to the collar. The teething portion has an outer engaging surface with a plurality of protrusions extending outward therefrom, and a conduit extending longitudinally therein. Each of the protrusions has a pore configured to receive an amount of medication, which is dispersed upon an infant chewing the device to compress the teething portion into the conduit and distort the volume of the pore.

### FIELD OF INVENTION

The present invention is directed to an infant teething device for delivering a desired amount of medication to an infant's gums.

### BACKGROUND OF THE INVENTION

The process of teething is a natural occurrence that is encountered by infants in their first two to three years of life. Through the eruption of teeth through the gums, infants often experience pain and discomfort that is typically addressed through the use of chewable objects or certain types of medications. More specifically, topical anesthetics, such as benzocaine, are often applied to areas of the infant's gums that are irritated.

The primary problem with the use of such topical anesthetics is the application of a proper dosage of the medication, over time, to areas that are specifically irritated. For example, caregivers may dispense a proscribed amount of topical anesthetic onto their finger or other object for rubbing onto the infants gums. This method is problematic for a number of reasons. First, the infant usually is too young to communicate which specific gum areas are in discomfort. Therefore, medicine is needlessly wasted by applying it over all the gum areas. Second, if a dosage of anesthetic is applied all at one time, discomfort may resume within a short period of time as the medicine wears off. As most anesthetics can only be applied so often to avoid the risk of overdosing, the caregiver may not be able to quickly reapply the anesthetic.

Thus, what is desired is an infant teething device that allows an infant to administer topical anesthetics to gum areas that are in pain and/or discomfort. Such a device would also manage the distribution of such anesthetics over time so that the infant could not instantaneously “use up” the entire dosage.

### SUMMARY OF THE INVENTION

The present invention provides an infant teething device comprising a collar and a chewing portion having a plurality of protrusions for delivering a proscribed amount of medication to an infant's gums. The collar has a ring-shaped base with a hemispherically-shaped shoulder extending from the base. This arrangement allows the device to fit within a standard baby bottle for usage. The chewing portion is an elongated structure having a proximal end attached to the hemispherically-shaped shoulder, a free distal end, and an outer engaging surface. A plurality of protrusions extend outward from the outer engaging surface of the chewing portion. These protrusions each have a pore into which a fixed maximum amount of medication may be placed. A conduit extends through the collar and laterally into a portion of the chewing portion and terminates within the chewing portion proximal to the free distal end. In this arrangement, medicine placed within the pores is selectively expelled therefrom upon an infant compressing the chewing portion into the conduit with their teeth and/or gums to reduce the volume of the pores.

### BRIEF DESCRIPTION OF THE DRAWINGS

FIG. 1 is a perspective view of the infant teething device in accordance with an embodiment of the present invention.

FIG. 2 is a top plan view of the infant teething device of FIG. 1.

FIG. 3 is a sectional view taken along line 2-2.

FIG. 4 is a side elevational view of the infant teething device of FIG. 1.

FIG. 5 is a front elevational view of the infant teething device of FIG. 1.

FIG. 6 is a rear elevational view of the infant teething device of FIG. 1.

### DETAILED DESCRIPTION OF THE INVENTION

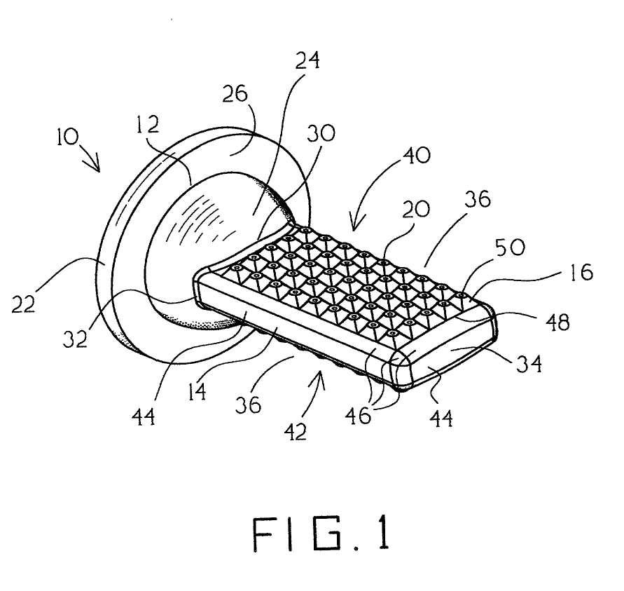

The infant teething device of the present invention is shown generally at 10 in FIG. 1. The device 10 comprises a collar section 12 and a teething or chewing portion 14 extending from the collar and having a number of hollow protrusions 16 into which medicine may be placed. In this arrangement, when an infant chews on the teething portion 14 with their teeth and/or gums, such teething portion is compressed towards a conduit 18 therein, best seen in FIG. 3. This compression causes flexure in the protrusions 16, which reduces the volume of pores 20 into which topical anesthetic is placed, thereby expelling the anesthetic onto the infant's gums for relief of pain and discomfort. The infant teething device is preferably made of a compressible, rubber-like material that can be molded as a one piece unit. Such materials may include natural rubber or silicone, and should be safe enough for an infant to insert into their mouth.

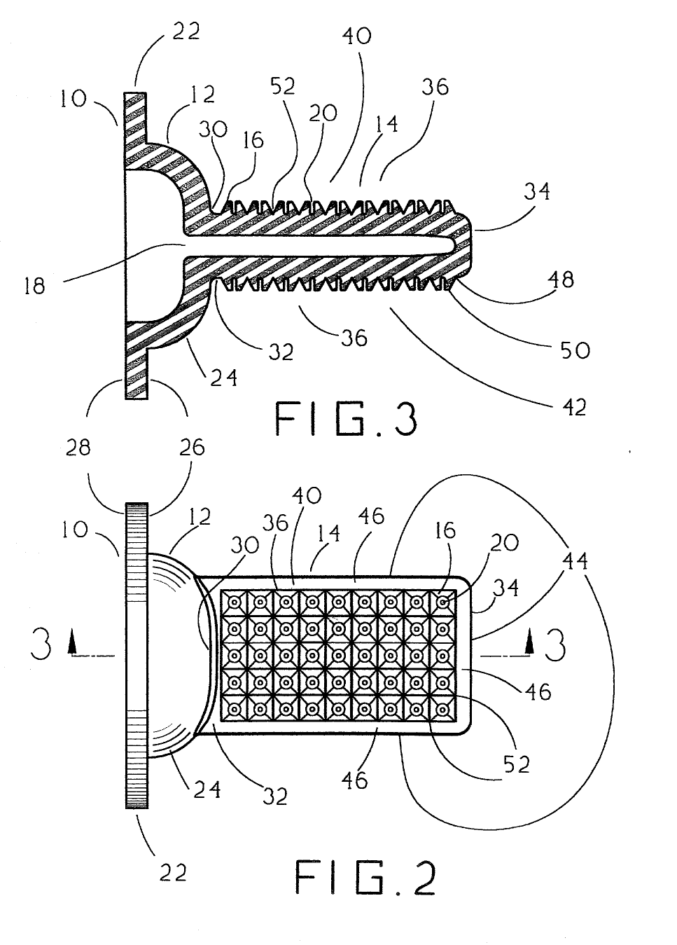

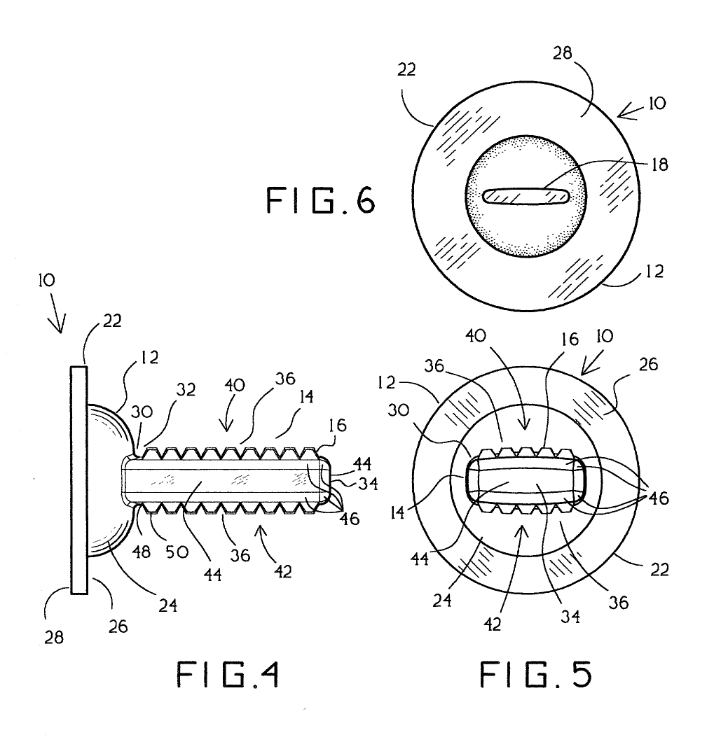

The collar section 12 has a base section or guard 22 that is preferably ring-shaped and a hemispherically-shaped shoulder 24, as seen in FIGS. 1, 2 and 4. Opposing first and second planar surfaces 26, 28 are formed on guard 22 and the shoulder 24 extends from the first planar surface. FIGS. 3 and 6 show the conduit 18 formed in the collar section 12 and extending generally laterally inward from the second planar surface 28 into teething portion 14. The section of the conduit 18 within the collar section 12 preferably begins with a disk shape and transitions into a hemispherical shape to mimic the overall shape of the collar. Preferably, the collar section 12 is sized and configured to allow the device 10 to be placed within the neck of a baby bottle for usage, with the guard 22 having a diameter of about 1 7/16 inches for standard sized baby bottles. In this way, device 10 is secured much like a standard nipple on a bottle. Also, the shoulder 24 preferably has a diameter of about 15/16 of an inch where the shoulder intersects the first planar surface 26, as seen in FIG. 5, to allow an infant to rest their lips thereon while using the teething portion 14. The collar section 12 also provides an infant with a sturdy handle that they can grasp while chewing on the teething portion 14 and allows for easy identification of the functional end of the device (i.e., the teething portion) such that the infant places the device 10 correctly in their mouth. Further, the guard 22 inhibits the infant from accidentally swallowing the device 10 because of its relatively large diameter.

The teething portion 14 extends laterally outward generally from a central region 30 of the hemispherically-shaped shoulder 24 at a proximal end 32 thereof, and terminates at a free distal end 34, as seen in FIGS. 1-4. The teething portion 14 is generally rectangular in shape, and conduit 18 extends longitudinally therethrough and terminates near distal end 34. The conduit 18 section within the teething portion 14 has a shape that generally mimics that of the teething portion, as seen in FIGS. 3 and 6. The conduit 18 should be sized such that the device 10 has the right amount of resilience for chewing by an infant to compress the teething portion 14 and distort volume of pores 20 to expel medication. An outer engaging surface 36 is provided with a plurality of protrusions 16 extending therefrom. The protrusions 16 are located on at least one of upper and lower exterior surfaces 40, 42 of the teething portion, and preferably on both surfaces such that an infant can simultaneously chew on the device 10 with both upper and lower sets of gums and/or teeth. A smooth exterior side surface 44 extends around a perimeter edge of the teething portion 14. To allow for ease in insertion of the teething portion 14 into the infant's mouth, beveled edges 46 may be provided between the exterior side surface 44 and the upper and lower exterior surfaces 40, 42 having protrusions 16. Ideally, the teething portion 14 has a length of about 1⅛ inches a width of about ¾ inches.

Each protrusion 16 extends outwardly from the outer engaging surface 36 and preferably tapers in width from a base section 48 to a tip 50. Each pore 20, preferably cylindrical in shape, is disposed within each protrusion 16 to store a proscribed amount of medication dosage. The protrusions 16 can be of a variety of shapes, such as conical, and preferably are pyramidal with a 4-sided base 48 and a sectioned flat upper surface or tip 50. In the pyramidal arrangement, the protrusions ideally have a width of about ⅛ of an inch at the base section 48, a width of about 1/16 of an inch at the tip 50, and a height of about 1/16 of an inch. This configuration allows the protrusions 16 to form a set of rows and columns defining a plurality of transverse and longitudinally aligned, interspaced grooves 52. These grooves 52 facilitate the cleaning and removal of excess topical anesthetic and other debris from the outer engaging surface 36.

Ideally, the pores 20 of the protrusions 16 are sized with a specific volume, and a specific number of protrusions with pores are provided, such that a total pore volume does not exceed the volume dosage of medication recommended for infant topical anesthetics, such as 7 percent concentration of benzocaine. Thus, when medication is applied in the proper dosage to the pores 20 of the protrusions 16, and the excess is removed from the grooves 52 of the outer engaging surface 36, there is no danger of overdosage to the infant. The depth of the pores 20 should be at least twice as large as the pore width or diameter to ensure that medicine dispersion from the pores takes place over time and with a moderate amount of compression effort required by the infant's teeth and/or gums. Ideally, the pore depth is about 0.06 inches and the pore diameter is about 0.02 inches. In an exemplary configuration, 45 pores may be used (9 rows by 5 columns of protrusions 16), but any number may be chosen so long as the total pore volume for holding medication is not exceeded.

Because the protrusions 16 extend outward from the outer engaging surface 36, the pores 20 are well positioned to administer medication directly onto irritated areas of the infant's gum as the device 10 is being used. The tapering of the protrusions 16 in width from the base section 48 to the tip 50 provides the protrusions with the proper amount of rigidity; the protrusions are narrow enough at the tip 50 to provide some flex for expelling medicine from the pores 20, but wide enough at the base 48 as to avoid buckling and excessive distortion by the infant's gums which would expel excessive medicine quickly. Also, the protrusions 16 are shaped to aid in the eruption of underlying teeth in the infant's gums.

By way of use, a recommended dosage of topical anesthetic is disperse from a medicine container and rubbed onto the protrusions 16 of the device 10 to work the medicine into the pores 20. Because of the transverse and longitudinally aligned grooves 52, excess medication that passes into the grooves can be easily removed, for example with a cotton swab or toothbrush, and reapplied to the protrusion tips 50 to completely fill the pores 20, or can be discarded. The teething portion 14 can then be placed in an infant's mouth. As the infant uses their teeth and/or gums to compress the teething portion 14 into the conduit 18, the protrusions 16, more specifically the pores 20, are compressed laterally and vertically to reduce the pore volume and expel traces of gel to soothe areas of gum irritation. Also as a result of the chewing action by the infant, saliva will aid in lifting the deposits of gel deep inside the pores 20 to fully use up the dosage of medication.

While certain forms of the present invention have been illustrated and described herein, it is not to be limited to the specific forms or arrangement of parts described and shown.

What is claimed is:

1. An infant teething device comprising:
a collar having a portion extending radially in a first plane;
a teething portion extending laterally from the collar and aligned longitudinally in a direction generally orthogonal to the first plane of the portion of the collar, and having an outer engaging surface and a conduit extending longitudinally therein; and
a plurality of protrusions extending outward from the outer engaging surface of the teething portion, each protrusion have a pore configured to receive an amount of medication.

2. The device of claim 1, wherein the collar is sized and configured to fit within the neck of a standard baby bottle.

3. The device of claim 2, wherein the annular collar has a diameter equal to or less than about 1 7/16 inches.

4. The device of claim 1, wherein the collar comprises:
a ring-shaped guard having a first planar surface; and
a hemispherically-shaped shoulder extending from the first planar surface, the teething portion extending from the shoulder.

5. The device of claim 4, wherein the ring-shaped guard and hemispherically-shaped shoulder have a hollow center region from which the conduit of the teething portion extends.

6. The device of claim 1, wherein the outer engaging surface comprises upper and lower exterior surfaces from which the plurality of protrusions extend.

7. The device of claim 4, wherein the teething portion further has exterior sides surfaces orthogonal to the upper and lower exterior surfaces, and beveled edges formed between the upper and lower exterior surfaces and the side surfaces.

8. The device of claim 1, wherein a specific volume of each pore and number of protrusions are provided based on the maximum allowable volume dosage of medication recommended.

9. The device of claim 1, wherein the plurality of protrusions form a set of rows extending transversely across the outer engaging surface and a set of columns extending longitudinally across the outer engaging surface, the set of rows and columns defining a plurality of transverse and longitudinally aligned grooves therebetween.

10. The device of claim 1, wherein the plurality of protrusions have a pyramid shape with a sectioned flat upper surface.

11. The device of claim 1, wherein the pore of each protrusion is cylindrically shaped.

12. The device of claim 1, wherein the depth to width ratio of the pores is greater than about 2 to 1.

13. The device of claim 1, wherein the plurality of protrusions each taper in width moving away from the outer engaging surface.

14. An infant teething device comprising:
a collar having a ring-shaped base with a first planar surface and a hemispherically-shaped shoulder extending from the first planar surface;
a chewing portion having a proximal end attached to the hemispherically-shaped shoulder, a free distal end, and an outer engaging surface;
a plurality of protrusions extending outward from the outer engaging surface of the chewing portion, each protrusion having a cylindrical pore therein;
a conduit extending through the collar and laterally into a portion of the chewing portion and terminating within the chewing portion proximal to the free distal end; and
whereby medicine placed within the pores is selectively expelled therefrom upon compression of the chewing portion into the conduit to reduce the volume of the pores.
